(19) United States
(12) Patent Application Publication
(10) Pub. No.: US 2013/0103695 A1
(43) Pub. Date: Apr. 25, 2013

(54) MACHINE TRANSLATION DETECTION IN WEB-SCRAPED PARALLEL CORPORA

(71) Applicants: Spencer Taylor Rarrick, Seattle, WA (US); William Duncan Lewis, Seattle, WA (US); Christopher Brian Quirk, Seattle, WA (US); Anthony Aue, Seattle, WA (US)

(72) Inventors: Spencer Taylor Rarrick, Seattle, WA (US); William Duncan Lewis, Seattle, WA (US); Christopher Brian Quirk, Seattle, WA (US); Anthony Aue, Seattle, WA (US)

(73) Assignee: Microsoft Corporation, Redmond, WA (US)

(21) Appl. No.: 13/278,194

(22) Filed: Oct. 21, 2011

(51) Int. Cl. G06F 17/30

(52) U.S. Cl. 707/748; 707/758; 707/E17.009

(57) ABSTRACT

Various technologies described herein pertain to detecting machine translated content. Documents in a document pair are mutual lingual translations of each other. Further, document level features of the documents in the document pair can be identified. The document level features can correlate with translation quality between the documents in the document pair. Moreover, statistical classification can be used to detect whether the document pair is generated through machine translation based at least in part upon the document level features. Further, a first document can be a machine translation of a second document in the document pair or a disparate document when generated through machine translation.

### BACKGROUND

Extraction of parallel corpora from bilingual websites can be utilized to acquire training data for use in statistical machine translation (SMT), cross-lingual information retrieval, and various other multi-lingual natural language processing (NLP) applications. Several systems have been developed to identify parallel documents on the web. These systems do well at identifying documents that are roughly equivalent in structure and information content, but they do little to confirm that the actual content of the extracted pages is suitable for use as training data. However, this kind of content often includes parallel text that is of inferior linguistic quality, most notably content that was generated by a machine translation system.

There are several reasons why web-scraped data may not be suitable for use as training data. The past few years have seen a dramatic increase in the prevalence of machine translated content on the web. Machine translated text is typically considered to be of much lower quality than human translated text, and so in general it is commonly preferable not to use it as a model for an application that generates text of its own. Machine translated content generally includes at least some incorrectly translated words and phrases. By training, for example, a statistical machine translation system with a training corpus that includes such content, erroneous mappings are likely to be introduced into the phrase table, which dilutes the weights of correct mappings.

The amount of machine translated content on the web varies by language. Naturally, for high density languages such as English, Japanese, and German, a small percentage of web pages typically are generated by a machine translation system. However, the amount of machine translated content on the web may rise sharply for lower density languages such as Latvian, Lithuanian and Romanian. For instance, the percentage of web content in languages such as Latvian and Lithuanian generated by machine translation systems can be over 50%. These languages suffer from the scarcest supply of parallel corpora to begin with, so the addition of web-scraped content has the potential to significantly increase the available amount of data. However, such web-scraped content is commonly contaminated with machine translated content, and thus, conventional use of such web-scraped content to train a statistical machine translation system can introduce errors and decrease performance of the statistical machine translation system.

### SUMMARY

Described herein are various technologies that pertain to detecting machine translated content. Document level features of documents in a document pair can be identified, where the documents in the document pair are mutual lingual translations of each other. Further, the document level features correlate with translation quality between the documents in the document pair. Moreover, statistical classification can be used to detect whether the document pair is generated through machine translation based at least in part upon the document level features. For instance, when generated through machine translation, a first document can be a machine translation of a second document in the document pair or a disparate document.

According to various embodiments, a subset of document pairs from a set of document pairs can be detected as being generated through machine translation. For instance, the subset of the document pairs can be detected as being generated through machine translation based on sentence level features, document level features, or a combination of sentence level features and document level features. Further, the subset of document pairs detected as being generated through machine translation can be removed from the set of document pairs to produce a filtered remainder of the document pairs. Moreover, the filtered remainder of the document pairs can be used to train a machine translation engine. The machine translation engine can be trained without using the subset of the document pairs detected as being generated through machine translation.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that detects machine translated content.

FIG. 2 illustrates a functional block diagram of an exemplary system that detects and filters machine translated content.

FIG. 3 illustrates a functional block diagram of an exemplary system that uses machine translation detection for search engine indexing.

FIG. 4 illustrates a functional block diagram of an exemplary system that detects machine translated content based on sentence level features and document level features.

FIGS. 5-6 illustrate exemplary sentence pairs that demonstrate the difference between legitimate out-of-vocabulary (OOV) tokens and tokens that result from machine translation.

FIG. 7 illustrates an exemplary sentence pair with ellipses and mismatched parentheses.

FIG. 8 illustrates an example of a sentence before and after a conversion process performed in connection with extracting function word features and suffix features.

FIG. 9 is a flow diagram that illustrates an exemplary methodology for detecting machine translated content.

FIG. 10 is a flow diagram that illustrates an exemplary methodology for detecting and removing machine translated content from a set of document pairs used to train a machine translation engine.

FIG. 11 illustrates an exemplary computing device.

### DETAILED DESCRIPTION

Various technologies pertaining to detecting machine translated content are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, various technologies pertaining to detecting low quality document pairs from a set of document pairs are described. A supervised learning approach for improving efficacy of web-extracted corpora by detecting and excluding low quality document pairs is provided herein. A filtered remainder of document pairs, with the low quality document pairs excluded, can be used to improve the quality of a machine translation system.

While much of the discussion herein relates to detecting and/or removing machine translated content, it can sometimes be difficult for a human to distinguish between errors that are caused by machine translation and other types of errors; accordingly, non-machine translated document pairs can also be removed if such non-machine translated document pairs are harmful to overall system performance. Thus, while many of the examples set forth herein relate to detecting whether a parallel document pair or sentence pair is machine translated or human translated, it is to be appreciated that these examples can be extended to detecting whether the mutual lingual translations between the parallel document pair or sentence pair is low quality or high quality.

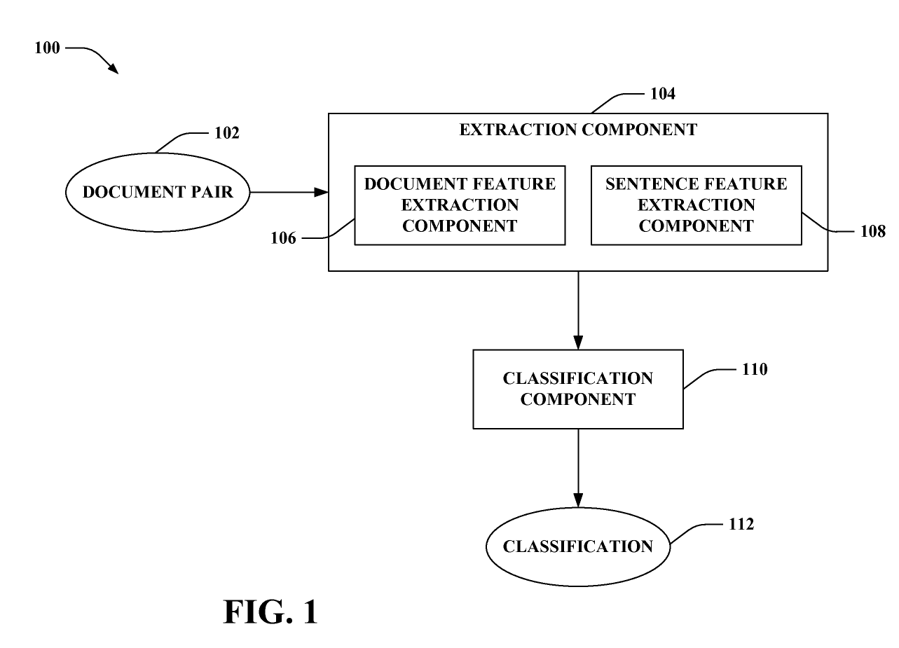

Referring now to the drawings, FIG. 1 illustrates a system 100 that detects machine translated content. A document pair 102 can be inputted to the system 100. The document pair 102 includes documents that are mutual lingual translations of each other. For example, the document pair 102 can be included in a set of document pairs. According to an example, the set of document pairs can be collected through web-scraping; however, the claimed subject matter is not so limited.

The system 100 includes an extraction component 104 that extracts a feature (or a plurality of features) from the document pair 102. According to various embodiments, the extraction component 104 can optionally include a document feature extraction component 106 that can extract a document level feature (or document level features) from the document pair 102. A document level feature can correlate with translation quality between the documents in the document pair 102. In accordance with other embodiments, the extraction component 104 can optionally include a sentence feature extraction component 108 that can extract a sentence level feature (or sentence level features) from the document pair 102. A sentence level feature can correlate with translation quality between sentences (e.g., aligned sentences) within the documents in the document pair 102. In other embodiments, the extraction component 104 can optionally include the document feature extraction component 106 and the sentence feature extraction component 108.

Moreover, the system 100 includes a classification component 110 that detects whether the document pair 102 is generated through machine translation based upon the feature(s) extracted from the document pair 102 by the extraction component 104. The classification component 110 can determine that the document pair 102 is generated through machine translation when a first document in the document pair 102 is detected to be a machine translation of a second document in the document pair 102 or a disparate document (e.g., not included in the document pair 102). Further, the classification component 110 can output a classification 112 for the document pair 102; the classification 112 outputted by the classification component 110 can indicate that the document pair 102 is generated through machine translation (e.g., machine translated, low quality translation, etc.) or generated through human translation (e.g., human translated, high quality translation, etc.).

The classification component 110 can perform statistical classification to analyze whether the document pair 102 is machine translated or human translated. Pursuant to an example, the classification component 110 can be a maximum entropy classifier. By way of another example, the classification component 110 can be a plurality of maximum entropy classifiers. Yet, it is contemplated that the claimed subject matter is not limited to the foregoing examples as it is to be appreciated that the classification component 110 can be substantially any type(s) of classifier and/or any number of classifiers.

The classification 112 can be a score assigned by the classification component 110 to the document pair 102. The score reflects a confidence that the document pair 102 is human translated (or machine translated) and that the translation is adequate and fluent on both sides. The term “side” refers to the half of the document pair 102 or sentence pair that comes from one of the two languages under consideration.

The document pair 102 can be fed to the system 100 along with various data as part of a document pair object. For example, the document pair object can include a Uniform Resource Locator (URL) of each side of a web page, full Hypertext Markup Language (HTML) for each side, a list of aligned sentence pairs, sentence-broken text for each side, and static rank for each side (e.g., static rank is a measure of relative importance of a web page, used in indexing). However, it is to be appreciated that disparate data can be included in the document pair object associated with the document pair 102 and/or a subset of the foregoing data need not be included in the document pair object associated with the document pair 102.

The classification component 110 can assign the classification 112 (e.g., the score) based on a single feature vector extracted by the extraction component 104 for the document pair 102. According to an illustration, if a set of document pairs are inputted to the system 100, then the classification component 110 can assign respective classifications (e.g., respective scores) based on a single feature vector extracted by the extraction component 104 for each document pair in the set.

By way of example, the classification component 110 can detect whether the document pair 102 is generated through machine translation based upon document level features extracted by the document feature extraction component 106 for the document pair 102. According to another example, the classification component 110 can detect whether the document pair 102 is generated through machine translation based upon sentence level features extracted by the sentence feature extraction component 108 for the document pair 102. In accordance with yet another example, the classification component 110 can detect whether the document pair 102 is generated through machine translation based upon document level features extracted by the document feature extraction component 106 and sentence level features extracted by the sentence feature extraction component 108 for the document pair 102.

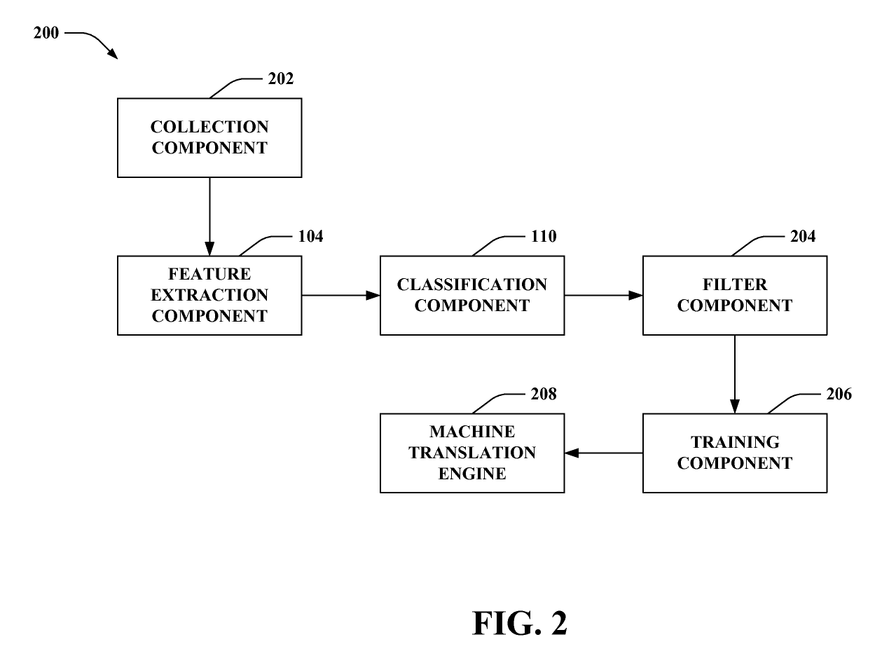

With reference to FIG. 2, illustrated is a system 200 that detects and filters machine translated content. The system 200 includes a collection component 202 that obtains a set of document pairs from websites. For example, the collection component 202 can employ web-scraping to collect the set of document pairs from websites. Hence, the collection component 202 can obtain web-scraped parallel corpora.

By way of illustration, the collection component 202 can employ various techniques to identify candidate pairs of pages that may be mutual translations of one another (henceforth “document pairs”). For example, the collection component 202 can examine hyperlinks for language names. If a page contains a link labeled “English” or “Anglais” and, within a certain number of lines, another link is labeled “French” or “Français”, there is a reasonable probability that the linked pages constitute a document pair. Likewise, if a French page has a link labeled “English” or “Anglais”, the linked page may be an English translation of the French page containing the link. Thus, for instance, the collection component 202 can identify pages containing the relevant combination of links using a search engine. Additionally or alternatively, the collection component 202 can identify candidate pairs by using a crawler to download entire web sites and look for pairs of pages within a given site with characteristic URL patterns (e.g., the URL for the Chinese version may be identical to the URL for the English version, with “ch” substituted for “en”).

Once candidate pairs have been identified by the collection component 202, structural filtering can be applied to determine whether the candidate pairs do in fact constitute a document pair, which can be included in the set of document pairs. This determination can rely on the fact that document pairs that include documents that are mutual lingual translations of each other tend to share certain structural properties. Each side of the candidate document pair can be reduced to a linearized 334114.01 sequence of markup tags (e.g. “START:HTML”, “END:TITLE”, etc), and chunks of text with associated size. A filter (e.g., the collection component 202) can then make a determination for each candidate pair based on the correlation in length of aligned chunks of text and the number of mismatches found in the markup tags.

Additionally, it is contemplated that the collection component 202 can use linguistic content in the documents during filtering to determine whether a candidate pair constitutes a valid document pair. Hence, the collection component 202 can use translation lexicons and cognates to find tokens (e.g., instance of a word, punctuation character, number, etc.) on each side of the document pair that are mutual translations of one another. A similarity score between two documents can then be calculated by the collection component 202 as a ratio of translational token pairs to total tokens in one side of the document pair. However, it is to be appreciated that the claimed subject matter is not limited to the foregoing illustrations related to collecting the set of document pairs.

Moreover, the feature extraction component 104 can extract a feature (or plurality of features) from the document pairs in the set of document pairs obtained by the collection component 202. For example, the feature extraction component 104 can identify one or more document level features of the document pairs in the set of document pairs. According to another example, the feature extraction component 104 can identify one or more sentence level features of the document pairs in the set of document pairs. Pursuant to yet another example, the feature extraction component 104 can identify one or more document level features and one or more sentence level features of the document pairs in the set of document pairs.

The system 200 further includes the classification component 110 which can detect a subset of document pairs from the set of document pairs as being generated through machine translation. The classification component 110 can assign respective scores to the document pairs in the set of document pairs based on corresponding confidences that lingual translations are adequate and fluent. Thus, the classification component 110 can determine whether document pairs in the set of document pairs are machine translated or human translated.

Further, the classification component 110 can detect the subset of the document pairs as being generated through machine translation based on the feature (or features) extracted by the feature extraction component 104. According to an example, the classification component 110 can detect the subset of the document pairs as being generated through machine translation based on sentence level features. Pursuant to another example, the classification component 110 can detect the subset of the document pairs as being generated through machine translation based on document level features. By way of a further example, the classification component 110 can detect the subset of the document pairs as being generated through machine translation based on document level features and sentence level features.

Moreover, the system 200 includes a filter component 204 that removes the subset of the document pairs detected as being generated through machine translation from the set of document pairs to produce a filtered remainder of the document pairs. Accordingly, the filter component 204 can filter machine translated content from the web-scraped parallel corpora obtained by the collection component 202.

The system 200 further includes a training component 206 that trains a machine translation engine 208 using the filtered remainder of the document pairs and without using the subset of the document pairs detected as being generated through machine translation. Hence, web-scraped parallel corpora can be cleaned for use in training statistical machine translation systems (e.g., the machine translation engine 208, etc.). The web-scraped parallel corpora can be cleaned by detecting (e.g., with the feature extraction component 104 and the classification component 110) and removing (e.g., with the filter component 204) machine translated content. Accordingly, since the machine translated content included in the web-scraped parallel corpora can be removed, the training component 206 can train the machine translation engine 208 on human translated content without training the machine translation engine 208 on machine translated content. Training the machine translation engine 208 using machine translated content can introduce errors and detrimentally impact performance of the machine translation engine 208. Hence, exclusion of the machine translated content from the web-scraped parallel corpora by the filter component 204 can improve the quality of the machine translation engine 208 over time as trained by the training component 206. Moreover, it is contemplated that a different document can be translated with the machine translation engine 208 as trained.

The system 200 can be employed to locate and remove document pairs that, although aligned, do not constitute high quality translation pairs. Thus, document pairs where one side has been generated by a machine translation system, and therefore may include disfluent sentence pairs, can be identified and removed. Moreover, it is also possible that both sides have been machined translated from some alternate source. Accordingly, the system 200 can generate a clean parallel corpus that can increase the number of correct and useful example translations while decreasing the number of incorrect or harmful translations. In contrast, conventional techniques typically provide tools for evaluation and error analysis of a machine translation system.

The system 200 can use types of information not typically available in conventional machine translation detection approaches. The system 200 operates on pairs of web pages, and thus, the URL and HTML for those pages can be accessible to the system 200. The URL and the HTML may include clues to the quality of the translation that are not included in the text of the documents.

Further, the system 200 can evaluate document pairs on a document level rather than a sentence level. Hence, the system 200 can aggregate clues over a sample of text that is larger than a sentence, which can provide a more confident judgment as to the quality of that text. Moreover, the system 200 has access to both sides of the document pair, which can enable comparing aligned sentences, looking at word alignments in those aligned sentence pairs, and comparing other items that may be preserved on both sides of a high quality translation (e.g., certain types of punctuation, etc.). Because of these additional sources of information, the system 200 differs from conventional techniques that detect machine translation from the textual content of a single sentence in isolation.

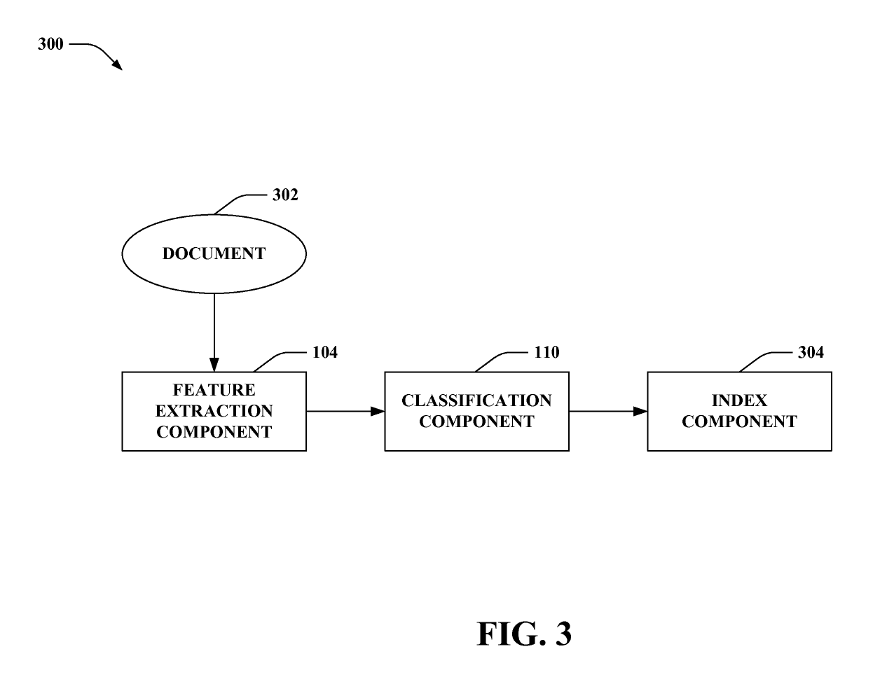

Referring now to FIG. 3, illustrated is a system 300 that uses machine translation detection for search engine indexing. In the system 300, a document 302 (e.g., documents in the document pair 102 of FIG. 1) can be provided to the feature extraction component 104. The feature extraction component 104 can identify feature(s) (e.g., document level feature(s) and/or sentence level feature(s)) of the document 302 (or documents in a document pair). Moreover, the classification component 110 can detect whether the document 302 (or the document pair) is generated through machine translation based upon the feature(s) identified by the feature extraction component 104.

Further, the system 300 includes an index component 304 that indexes the document 302 as a function of whether the document 302 is generated through machine translation (e.g., as detected by the classification component 110). The index component 304, for instance, can index documents in a document pair as a function of whether the document pair is generated through machine translation. For example, the index component 304 can rank machine translated documents below human translated documents. According to an illustration, the index component 304 can decrease a ranking for a document determined to be machine translated and can increase a ranking for a document determined to be human translated; however, it is to be appreciated that the claimed subject matter is not limited to the foregoing illustration.

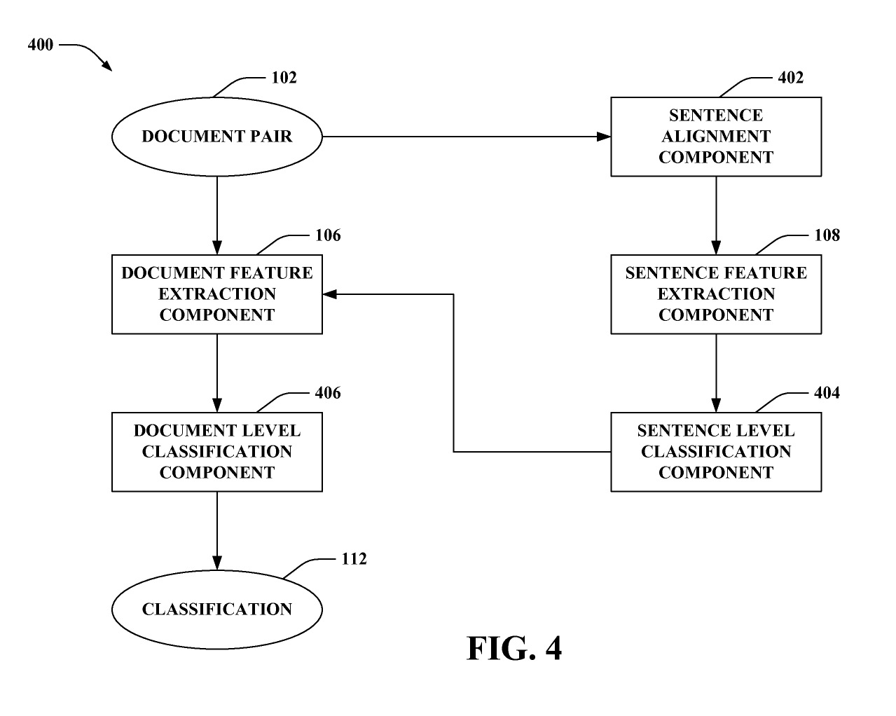

Now turning to FIG. 4, illustrated is a system 400 that detects machine translated content based on sentence level features and document level features. The document pair 102 can be inputted to the system 400. The system 400 can include a sentence alignment component 402, which can align sentences from documents of the document pair 102 to provide sentence pairs of the document pair 102. Further, the sentence feature extraction component 108 can identify sentence level feature(s) of the sentence pairs from the documents in the document pair 102.

Moreover, the system 400 includes a sentence level classification component 404 (e.g., sentence level classifier) that determines respective sentence level scores for the sentence pairs based on the sentence level features inputted from the sentence feature extraction component 108. The respective sentence level scores can be probabilistic measures related to whether the corresponding sentence pairs are generated through machine translation or human translation. Hence, the sentence level classification component 404 can score the aligned sentence pairs found in the document pair 102.

The system 400 also includes the document feature extraction component 106, which can identify document level features of the documents in the document pair 102. Moreover, the document feature extraction component 106 (and/or the sentence level feature classification component 404 or a disparate component (not shown)) can generate a derived document level feature (or a plurality of derived document level features) based on the sentence level scores outputted by the sentence level classification component 404. For instance, a distribution of the scores for the sentence pairs (e.g., number and proportion of sentence pairs that fall within a given score range) can be modeled with the document level features. Thus, the document feature extraction component 106 can generate a single feature vector for the document pair 102 based on the document level features extracted from the document pair 102 and the derived document level feature(s) generated based on the sentence level scores associated with the aligned sentence pairs from the document pair 102. Moreover, the single feature vector can be inputted to a document level classification component 406 (e.g., document level classifier) that can determine a document level score (e.g., the classification 112) for the document pair 102. The document level score, for instance, can be a probabilistic measure related to whether the document pair 102 is generated through machine translation or human translation.

The system 400 can process a large amount of data and can be used on a wide range of language pairs. Thus, the system 400 can make use of the following natural language processing and machine learning resources: a word breaker/tokenizer; an N-gram language model; a word-aligner; and a maximum entropy classifier/learner (e.g., the document level classification component 406, the sentence level classification component 404, etc.). According to an example, the word breaker/tokenizer can be implemented on a per language basis, while the other resources need not be implemented on a per language basis. Further, the system 400 can detect machine translated content without using parsers.

Various features can be extracted by the sentence feature extraction component 108 and/or the document feature extraction component 106. Examples of sentence level features and document level features that can be extracted from the document pair 102 are described below. It is to be appreciated that the features described herein or a subset thereof can be extracted from the document pair 102. For example, a combination of the features noted below can be extracted and utilized to generate the classification 112; however, the claimed subject matter is not so limited. Further, it is to be appreciated that all of the features provided herein need not be extracted and utilized to generate the classification 112. Moreover, it is contemplated that the list of features described herein may not be exhaustive, and instead, features other than the features set forth herein are intended to fall within the scope of the hereto appended claims.

The sentence feature extraction component 108 and the document feature extraction component 106 extract features that can be inputted to the sentence level classification component 404 and the document level classification component 406. The features can be divided into several groups. Although not shown, it is contemplated that the sentence feature extraction component 108 and/or the document feature extraction component 106 can include a plurality of feature extraction components, each of which can extract a subset of features from the document pair 102; thus, while the below discussion notes that the sentence feature extraction component 108 or the document feature extraction component 106 can extract respective sets of features, it is to be appreciated that such features can be extracted by other extraction components.

According to various examples, the sentence feature extraction component 108 can extract basic features. The basic feature group can include feature subgroups such as a general subgroup, an out-of-vocabulary (OOV) subgroup, and a lexical subgroup.

The general subgroup includes features for general statistics related to sentence length, such as counts of characters and tokens, and their ratio between the two sides. Accordingly, the general subgroup can include the following features: the number of characters and tokens on each side; the ratio of characters and tokens between the two sides; the average number of characters per token on each side, and the ratio of these numbers between the sides; and sentence length bucket indicator features. For instance, each side can fall into a bucket for 1 token, 2 tokens, 3-6 tokens, or more than 6 tokens, and thus, a sentence pair can fall into one of 16 possible combinations corresponding to the sentence length bucket indicator feature.

While one language may consistently use more characters or tokens to express a particular concept than another language, a rough correlation in length for human translated sentence pairs for the two given languages can exist. Hence, for good parallel sentence pairs, these ratios will generally be close to some particular number, and a large deviation from that number can be taken as evidence that the sentences are not in fact good translations of one another. Moreover, although the ratio features may work well for longer sentences, length ratios on shorter sentence pairs (such as menu items) can typically have a much higher variance due to the small number of tokens. By using sentence bucketing features (with finer-grained buckets for fewer tokens), the sentence level classification component 404 can learn a different distribution for these shorter sentences.

The out-of-vocabulary (OOV) subgroup can include features that relate to OOV tokens found in sentences. The OOV subgroup can include the following features: total number of OOV tokens per side; number of OOV tokens that include at least one alphabetic character; number of OOV tokens that include only alphabetic characters; and a number of untranslated words on each side. An “alphabetic” character, for instance, is defined by Unicode regular expressions and is not limited to the Roman alphabet.

The presence of OOV words in a sentence can be a good indicator of machine translated text. A token is considered OOV for a language if it is not present in a language model for that language. There are many reasons why an OOV token may show up in either a machine translated or human translated sentence. Proper names, misspellings, or identifiers from a code can be reasons for the presence of an OOV token in a legitimate, human translated sentence. Some technical words may also be OOV by this definition if the corpus used to train the language model did not contain many documents from that particular domain. On the other hand, OOV words may also be present due to a machine translation system copying an unknown word from an input to an output. In particular, the foregoing can be utilized to help identify machine translated content.

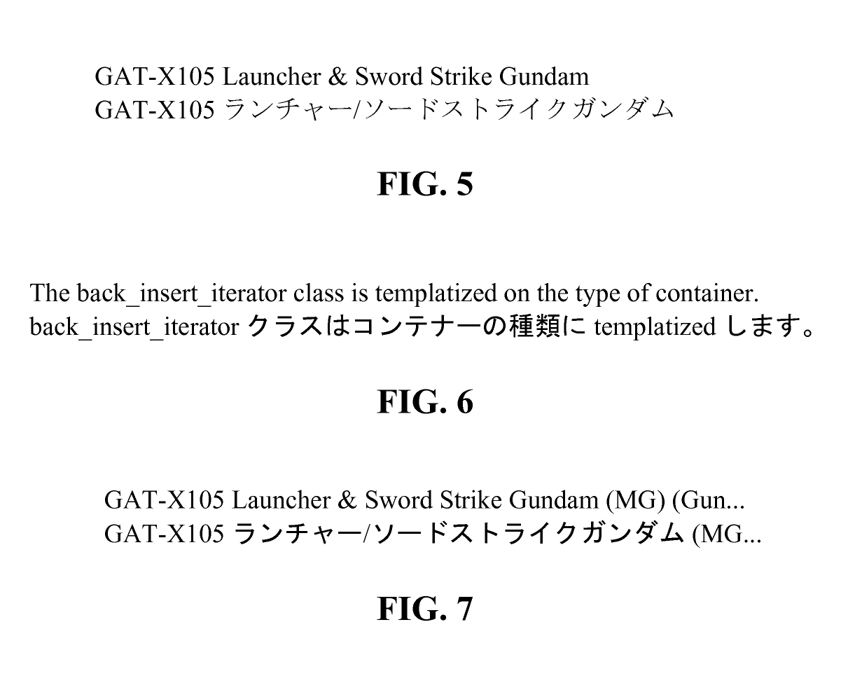

FIGS. 5 and 6 illustrate exemplary sentence pairs that demonstrate the difference between legitimate OOV tokens and tokens that result from machine translation. FIG. 5 shows an example of a toy model number that is likely OOV for both English and Japanese (“GAT-X105”), but would not be indicative of machine translation (e.g., this sentence pair in fact seems to be human-translated). In contrast, FIG. 6 Error! Reference source not found. includes two likely OOV words on the Japanese side: one is probably the result of a word left untranslated by a machine translation system (“templatized”), and one appears to refer to an identifier in a piece of code (“back_insert_iterator”). It would not be surprising to see OOV tokens such as the token that refers to the identifier in a piece of code in a human-written Japanese sentence that discusses a piece of code.

When examining the types of characters found in an OOV token, it can be expected that most OOV tokens that are present as a result of machine translation will contain only “alphabetic” characters. OOV tokens that contain other characters (e.g., “GAT-X105” in the first exemplary sentence pair of FIG. 5) are likely to be identifiers or even numbers. Note that “alphabetic” here is defined by a particular Unicode regular expression term, and many characters that are not from the Roman alphabet can still be considered “alphabetic.”

Again, reference is made to FIG. 4. When looking at a sentence mostly written in his or her native language, it is it is relatively straightforward for a human to identify whether a given token is actually an out of place word from another language. Making this distinction programmatically can be slightly more complicated due to the legitimate sources of OOV tokens mentioned above. Thus, the sentence feature extraction component 108 can employ a heuristic to help with this determination. The sentence feature extraction component 108 can identify a token as being “untranslated” if it appears identically on both sides of the sentence pair, contains only “alphabetic” characters, and is OOV according to one language's language model but not the language model of the other language.

Further, the lexical subgroup can include lexical indicator features for tokens in the sentence pair. The lexical subgroup can include a case-sensitive indicator feature for each token on each side and a case-insensitive indicator feature for each token on each side. The rationale for including these features is that any given machine translation engine can have a bias towards including certain words at the exclusion of their homonyms. Therefore, the presence of these favored words might lend confidence to an assertion that a particular sentence was in fact machine translated. Another function of these features can be to act as a proxy for a domain filter, as many words are highly correlated with a particular domain.

By way of another example, the sentence feature extraction component 108 can extract script features. The script feature group includes features that deal with character scripts (e.g., Hiragana, Roman, Cyrillic, etc.). More particularly, this group can include the following features: indicators for each script type appearing on each side; the count and ratio of characters on each side that belong to a given script; the ratio of characters from each script after discounting common characters; and indicators for whether each side contains or ends with an ellipsis.

Following this example, it is contemplated that the script features can be used since a high proportion of characters from a script not typically used in a language may be evidence of machine translation. This can be especially true if those characters are present in a sentence because of an 00V word that a machine translation system left untranslated from the source sentence. Moreover, including the script features can help to select pages within a language that fit into a certain domain, as an abundance or dearth of a particular script may be correlated with that domain. For example, parallel technical pages in Japanese that appear to be consistently high quality tend to contain more of the Katakana script than general domain Japanese text does, and so including script features will lead to the classifier ranking technical pages more favorably for English-Japanese. By doing so, the script features can indirectly help pick out higher quality pages.

Moreover, there can be a common script type, which includes characters common to many languages, such as numerals, spaces, and most punctuation marks. The proportion of common characters can have a relatively high variance even for good sentences, and thus can obscure the meaning of the ratios of other script types. Hence, additional features can be added for the ratio of various scripts after discounting common characters.

The script feature group can also include indicator features for the presence of an ellipsis on each side. Some websites may truncate sentences so that they fit into a certain width, and then append an ellipsis to indicate that truncation has occurred. Even though the original sentence may be human translated, these truncated sentence fragments will in many cases no longer have the same meaning. This is illustrated in the example in FIG. 7, which depicts a sentence pair with ellipses and mismatched parentheses. While the sides of the sentence pair from FIG. 7 were most likely equivalent before truncation, it is clear that the Japanese side of the sentence has been truncated slightly earlier than the English side. Because of the truncation, the two sides of this sentence pair also both have more opening parentheses than closing parentheses, and the number of such symbols is different between the two sides as well. Further, it is to be appreciated that features that model this sort of behavior with enclosing punctuation marks can be included in the token match feature group described below.

Additionally or alternatively, the sentence feature extraction component 108 can extract token match features. The token match feature group can include two subgroups: one for features related to tokens that are shared verbatim between the two sides, and another dealing with certain types of enclosing punctuation marks such as quotation marks, parentheses, and various types of brackets.

The token match subgroup that deals with tokens shared between sides can include the following features: count and ratio of word, numeral, and punctuation tokens on each side that do not have an exact match on the other side (e.g., “word” tokens can include tokens that are not punctuation and numerals); lexicalized indicator features for each token that does not have an exact match on the other side; and indicator features signifying that all or no tokens of a given type (e.g., word, number or punctuation) have exact matches on the other side. It is to be appreciated that a feature that denotes the number of tokens of a type that are matched need not be used, since this information can be derived from the total number of tokens and the number of unmatched tokens on each side; however, the claimed subject matter is not so limited.

It can be expected that numeral tokens can be copied exactly in a translation, so generally a low unmatched ratio can be identified for good translations. There can be some exceptions such as when unit conversions occur. For punctuation, the expected unmatched ratios vary by language pair and punctuation type. German and English share many of the same punctuation symbols, and so good translations between these two languages may tend to have a low unmatched ratio for punctuation. Japanese, on the other hand, typically uses different symbols for quotation marks, periods, and a higher unmatched ratio may be expected. For words, a low unmatched ratio could be an indication that some words were left untranslated by a machine translation system, but there are exceptions to this as discussed in relation to the OOV feature subgroup.

The other token match subgroup, which pertains to enclosing punctuation, makes use of two pairs of punctuation token classes. The two pairs of punctuation token classes are initial and final classes and open and close classes. The initial and final classes are two character classes that can include various types of opening and closing quotation marks, respectively. Moreover, the open and close classes include opening and closing parentheses, brackets, curly braces, and other similar grouping symbols.

Whether or not a particular token belongs to one of these classes can be determined by Unicode regular expressions. The features in this token match subgroup include many features that relate to various properties of tokens in these classes: counts for various enclosing punctuation character classes on each side; indicator feature for a mismatch in the number of tokens belonging to each enclosing feature character class between sides; and indicator features that signify a mismatch in the number of open/close or initial/final tokens on either side.

Some of these features deal with classes of punctuation marks matching between the two sides. This can capture some interesting patterns that cannot be captured with verbatim matching features. For example, although an open quotation mark may appear as a different token in Japanese and English, they will both be classified as the initial punctuation class by Unicode regular expressions (e.g., ‘┌ ┘’ are commonly used as quotation marks in Japanese).

The sentence feature extraction component 108 can also extract features to capture whether each enclosing punctuation symbol has a corresponding match on the same side. More open symbols than close symbols on a side may be an indication that the sentence was prematurely truncated—either by a sentence breaker or by whatever program generated the HTML that is scraped (e.g., as demonstrated in FIG. 7). While this may not help to detect machine translated sentences, it may point to sentence pairs that can no longer be considered equivalent due to truncation.

The sentence feature extraction component 108 can additionally or alternatively extract language model features. The features in the language model feature group make use of a standard trigram language model for each language, trained on a large monolingual corpus. The specific features extracted can include: mean, variance and sum of log probabilities of individual tokens on each side; and language model perplexity for each side. N-gram language model perplexity scores can have some correlation with human evaluations translation quality. However, the fact that SMT systems generally utilize a language model in decoding may limit their effectiveness in identifying sentences translated by such systems. Yet, language model scores may be useful when dealing with text translated by a rule-based system in particular, as the output of these systems is less likely to already be influenced by language model scores.

Further, the sentence feature extraction component 108 can additionally or alternatively extract function word features that correspond to patterns of functions words in the sentence pairs. Machine translated output can frequently contain misused function words. The function word feature group can capture patterns in function words that are characteristic of machine translated content. Curated lists of function words can be used if available; however, such lists may be unavailable for some languages. As a proxy, the M most common words for each language in a large monolingual corpus, where M can be substantially any integer (e.g., M can be 100, an integer less than 100, an integer greater than 100, etc.), can be identified and treated as function words.

When extracting function word features, as a preprocessing step, the sentence feature extraction component 108 can generate an altered form of each sentence, where non-function-word tokens are replaced by one of the following three class tokens based on the characters in the token: Num, Punc, or Unk. The Num class token can indicate that the token is a number (e.g., the token includes only Unicode digits, commas, and periods). The Punc class token can indicate that the token includes only Unicode punctuation characters. Further, the Unk class token can be used for any other token.

Tokens that appear in the list of function words can remain in their original form for lexicalized features, but for some other features that are concerned with token classes, these tokens can be considered to belong to a fourth class, Func. It is also contemplated that this scheme can be extended to use word classes (or parts of speech tags) for less frequent words instead of a generic Unk token.

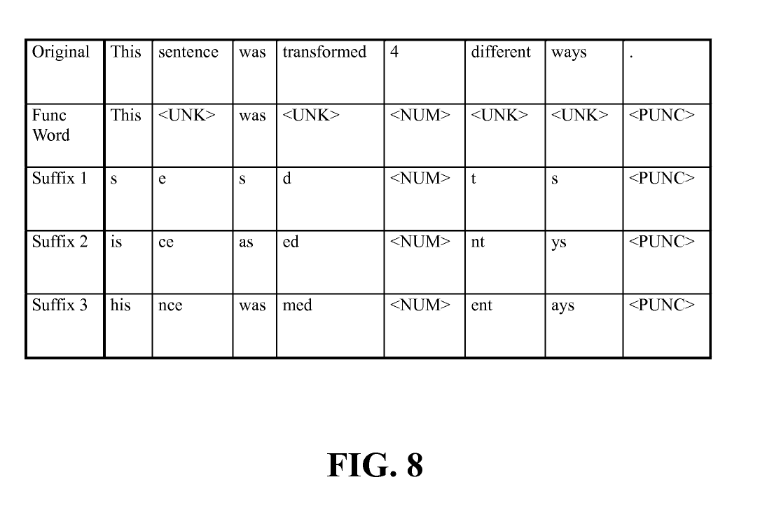

With reference to FIG. 8, illustrated is an example of a sentence before and after the conversion process performed by the sentence feature extraction component 108 for the function word feature group and for the suffix feature group (discussed below). For each language, a language model can be constructed over a large monolingual corpus of human written sentences that have been converted by the above process. In addition to calculating per token log probabilities and sentence perplexities, this language model can be used to identify function word n-grams that are out of vocabulary (e.g., unseen in the training corpus). By construction, tokens that appear in the converted sentences can be very common (e.g., they contain the M most common tokens), and therefore if an n-gram appears in a sentence and was not seen in the language model's training corpus, such a case can be a strong indicator of something amiss.

The following function word features can be included in this group: the count of each 1-, 2- and 3-gram in each side's converted form; the count and ratios of tokens of each class on each side (e.g., Func, Punc, Unk, Num); the logarithm and absolute value of logarithm of some quantities (e.g., the quantities can be the ratio of the two sides' function word ratios and/or the ratio of the two sides' punctuation ratios); the mean, variance, and sum of log probabilities over the function word language model; perplexity according to the function word language model; the ratio of the total and average per-token log probabilities for the two sides; the difference and absolute value of the difference of the two sides' average and total per-token log probabilities; the number of trigrams in each of the converted sentences that were out of vocabulary; and the number of tokens in the converted sentence for which the longest context seen in the training data was k (fork from 0 to 3).

Referring again to FIG. 4, the sentence feature extraction component 108 can additionally or alternatively extract suffix features that correspond to patterns in morphology and parts of speech for words in context. Morphology errors are a type of error commonly seen in machine translated text, especially when translating into morphologically rich languages such as Japanese.

Suffix features can be extracted by the sentence feature extraction component 108 without using part of speech taggers or morphological analyzers. Instead, the sentence feature extraction component 108 can use the final characters in each word as a proxy for morphology and part of speech. For instance, there can be correlations between certain suffixes and part of speech or morphology. By way of example, words ending in “ly” in English are overwhelmingly adverbs.

The suffix feature group can be extracted in a similar manner as compared to the function word feature group. An analogous conversion process to the sentences can be performed before extraction, but in this case, the words are reduced to their final k characters, as shown in FIG. 8. For example, three copies of the features for k from 1 to 3 can be extracted. As in the function word conversion process, punctuation and numeral tokens are reduced to Punc and Num, respectively, although tokens that do not fall into one of these categories are treated identically (e.g., there is no Func/Unk distinction). Moreover, three language models can be built over large monolingual corpora, each having been converted to the modified suffix form for one of the three suffix lengths.

The suffix features extracted can be similar to those for the function word feature group without including features analogous to those that deal with function word classes. Further, one instance of each feature can be extracted for each of the three suffix lengths. The suffix features can include the following: the count of each 1-, 2- and 3-gram in the converted form of each side; the mean, variance, and sum of per-token log probabilities over the suffix language models; perplexity on the suffix language models; the ratio of the total and average per-token log probabilities for the two sides; the difference and absolute value of the difference of the two sides' average and total per-token log probabilities; the number of trigrams in each of the converted sentences that are OOV in the suffix language model training data; and the number of tokens in the converted sentence for which the longest context seen in the training data was k (for k from 0 to 3).

Other sentence level features that can additionally or alternatively be extracted by the sentence feature extraction component 108 are alignment features. A word with multiple senses in one language can potentially translate to one of multiple words in another language depending on the sense and context. While human translators can be capable of picking up on these subtle differences in sense, this is an area that can give machine translation systems a great deal of trouble. Despite an effort to make use of context, many machine translation engines have a tendency to assume the wrong sense when translating, or to consistently allow one frequent translation to dominate the other possible translations, even when it uses the wrong sense.

To illustrate this point, consider the English word “as” which has many different senses (e.g., “Today is as hot as yesterday”, “I'm not hungry as I've already eaten”, “He worked for several years as a carpenter before retiring” among many others). Each use of “as” in these sentences may be translated into to a distinct Japanese word (e.g., hodo, node, toshite, respectively). However, upon examination of parallel web scrapes, it can be noticed that for machine translated content, the translation appropriate for the third sense (e.g., toshite) often appears when another would be more appropriate.

While there are certainly cases where this translation is appropriate, by narrowing the data set to sentence pairs containing “as” on the English side and “toshite” on the Japanese side can leave a higher concentration of machine translated sentences than in the data set as a whole. A word-aligner can employ the foregoing information. Given enough training data, the features may be able to learn patterns of aligned word-pairs, such as the one given above, that frequently occur in machine translated text. Conversely, if it is identified that “as” is aligned to one of the other possible translations, it may be considered evidence against a verdict of machine translation, for example.

To begin the processing for this feature group, the sentence feature extraction component 108 can run word-aligners in both directions on the sentence pair and also find the intersection of the directional alignments. The word aligners for each language pair can be trained on a large bilingual corpus of human translated content. Features below that do not specify directional alignments are extracted using the intersected alignment.

More particularly, the alignment features that can be extracted include the following: the score of the best or “viterbi” alignment in each direction; the sum of the scores of all alignments in each direction; the count and ratio of words with no alignment on each side; the count of aligned tokens; and lexicalized features. The lexicalized features can include lexicalized indicator features for each token that had an alignment on the other side, lexicalized indicator features for each token that did not have an alignment on the other side, and lexicalized indicator features for each aligned pair of tokens.

Another subset of alignment features makes use of the token classes described under the function word feature group (e.g., Func, Num, Punc, Unk). It can be expected that good translations tend to have more content words aligned with content words, function words to function words, etc. Accordingly, this subset of alignment features can include: indicator features for pairs of token classes for which there was at least one alignment (e.g., Func-Num, Punc-Punc, etc); the count of alignments for each pair of token classes; and for each side, the count of tokens of each class that did have an alignment and that did not have an alignment.

Moreover, the sentence feature extraction component 108 can extract features that deal with distortion and fertility of words according to word alignments. Such features can include: the number of tokens in each direction for which the relative distortion is k; the relative distortion for each token in each direction, lexically conditioned; the number of tokens in each direction with absolute distortion of k; the number of tokens in each direction with absolute distortion of k, when the order of the tokens on one side has been reversed; the number of tokens on each side with fertility of k; and the fertility of each token on each side, lexically conditioned.

Reverse absolute distortion can be used, for instance, since some languages, such as Japanese, tend to have a word order that is more or less reversed from that of English. To a certain extent, words at the beginning of an English sentence are more likely to appear near the end of a Japanese sentence. Accordingly, distortion can be measured in this manner to provide more useful patterns, for instance. Moreover, the term “relative distortion” refers to the difference in position between the token aligned with the current token and the token aligned with the token immediately preceding the current token.

Moreover, the document feature extraction component 106 can extract various document level features, for example. At the document level, a number of features that correlate with the translation quality of web pages can be identified and utilized rather than features that identify particular mistakes that tend to appear in machine translated text. The document level features (e.g., other than the sentence score features noted below), for instance, can enable identifying patterns in terms of what kinds of pages are likely to include higher or lower quality translations; however, the claimed subject matter is not so limited.

In accordance with various examples, the document feature extraction component 106 can extract basic document features. The basic document feature group can include quantitative properties of the document pair 102; yet, other features can also be included in the basic document feature group.

More particularly, the basic document feature group can include the following features: the number of aligned sentence pairs; the total number of sentences on each side (disregarding alignments); the ratio of sentences that have an alignment on each side; the ratio of the number of sentences between the two sides; static rank and the ratio of static ranks between the two sides; and an indicator feature for explicit translation markers found in the HTML for each side.

A rough correspondence in the number of sentences on each side for document pairs that are good translations of one another can be identified. Also, a high proportion of aligned sentences can signify good quality as well, for instance. According to other examples, each side's HTML can be examined by the document feature extraction component 106 for explicit indicators that a page was translated by a machine. Moreover, some of the foregoing features reference static rank, which is a numerical score assigned to each page according to its relative importance or prominence on the web for the purpose of search indexing. Hence, pages with a high static rank are likely to be well written. In addition to the raw static rank for each side of the document pair 102, the ratio between the static ranks of the two sides can also be determined by the document feature extraction component 106, as a large differential between the perceived importance of the two sides of the document pair 102 can be an indication that one side is of poor quality.

Further, the document feature extraction component 106 can determine sentence score features. For example, the sentence score features can be derived document level features based on sentence level scores generated by the sentence level classification component 404. Accordingly, the sentence score feature group can enable incorporating the output from the sentence level classification component 404 about the quality of individual sentence pairs into a determination of the quality of the document pair 102 as a whole. The sentence score features can include, for example, the mean and sum of scores assigned to all aligned sentence pairs, with each sentence pair weighted in each of three ways (e.g., uniformly, by token count, by character count), and the count and ratio of sentences in each score range or bucket. In accordance with an example, fourteen sentence score buckets can be utilized. Following this example, the buckets can include: x≦−1.0; x>3.0; and twelve uniformly sized buckets from −1.0 to 3.0.

Moreover, the document feature extraction component 106 can extract URL features corresponding to the document pair 102. The URL feature group can include features related to the URLs of the web pages from which the two sides of the document pair were scraped. More particularly, the following URL features for each side of the document pair 102 can be extracted by the document feature extraction component 106: an indicator feature for first part of the URL string, i.e. “http:”, “https:”, or whatever other string may appear before “//”; an indicator feature for the domain portion of the URL (e.g., everything between the first “//” and the next “/” in the URL); an indicator feature for each punctuation-delimited substring or token in the domain; an indicator feature for each punctuation-delimited token in the entire URL; the number of tokens and characters in the domain, and in the entire URL; and the count of each type of punctuation character appearing in the URL.

By way of further example, features that look at what the URLs of the two sides have in common can be extracted. According to an illustration, the length of the longest common substring, which tokens appear on both sides, and which tokens appear on only one side can be extracted by the document feature extraction component 106.

Further, certain URL domain names are likely to have more trustworthy pages than others. The length of the URL can also be indicative of quality, as can be the number and types of punctuation in the domain. Shorter URLs and fewer odd punctuation characters (other than ‘/’, ‘.’, ‘-’) tend to correspond to higher profile pages. Substrings of the URL often correspond to language codes, or in some cases correlate with a certain text domain. Also, the distinction between ‘http’, ‘https’, and other alternatives can in some cases be indicative of quality, perhaps indirectly through some text domain correlation.

After extracting features, it is contemplated that the feature vectors (e.g., produced by the document feature extraction component 106) can be preprocessed. According to an example, real-valued features can be discretized into quintiles. Additionally or alternatively, sentence level features that appear once in training data can be cut, which can reduce a number of lexicalized features, for example. It is to be appreciated, however, that the claimed subject matter is not limited to the foregoing examples.

Moreover, the sentence level classification component 404 and the document level classification component 406 can be trained for a given language pair. Accordingly, separate classification components can be trained for each language pair (e.g., Latvian-English has separately trained classification component(s) from Japanese-English, etc.). The sentence level classification component 404 and the document level classification component 406 can be trained and tested using data acquired by various techniques. For example, human annotation of randomly sampled document pairs scraped form the web can be used. According to another example, know or trusted translations can be used as positive examples and pseudo-negative examples can be generated with a machine translation engine. However, it is to be appreciated that the claimed subject matter is not limited to the foregoing examples.

It is further contemplated that other examples are intended to fall within the scope of the hereto appended claims. However, it is to be appreciated that the claimed subject matter is not limited to the below examples.

According to an example, sentence scores need not be aggregated by the document feature extraction component 106 over a document. Instead, a ranking for each sentence pair based on the score assigned by the sentence level classification component 404 can be used. A copy of the document level features (e.g., URL, basic feature group, etc.) can be included in the feature vector outputted for each sentence pair.

By way of another example, the sentence level information can be incorporated into the document level features in a different manner as compared to the above description. For instance, a plurality of sentence level classification components (e.g., similar to the sentence level classification component 404) can be trained (e.g., one per feature group), and multiple sets of sentence score bucket features can be extracted, one for each classification component, to the document feature vector. According to a further example, aggregates and counts of various sentence level features can be used at the document level (e.g., by the document feature extraction component 106, etc.). It is to be appreciated, however, that the claimed subject matter is not limited to the foregoing examples.

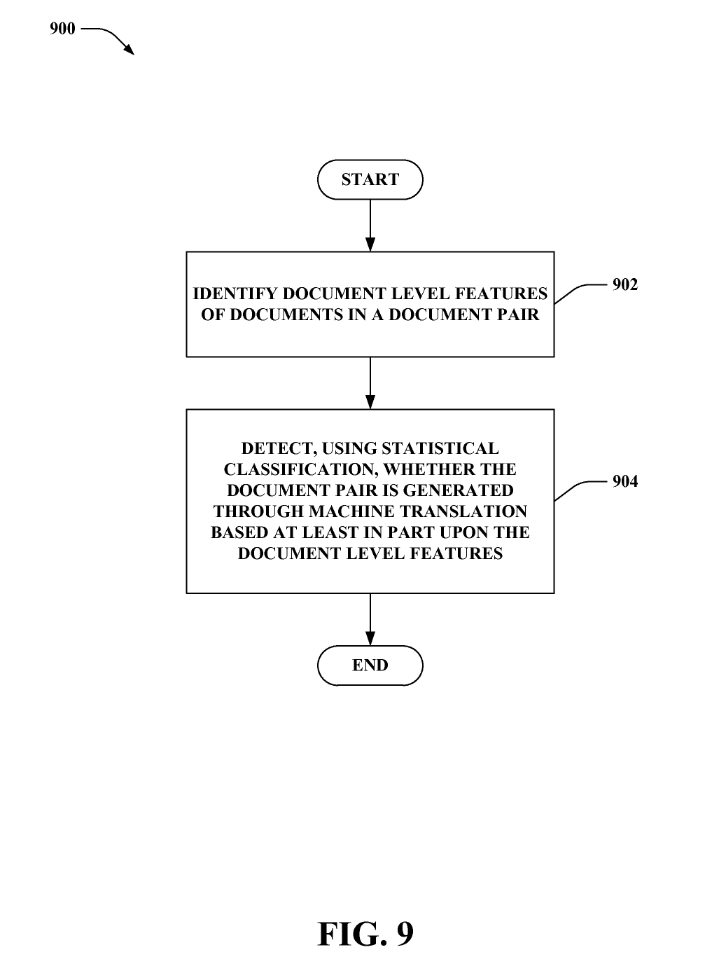

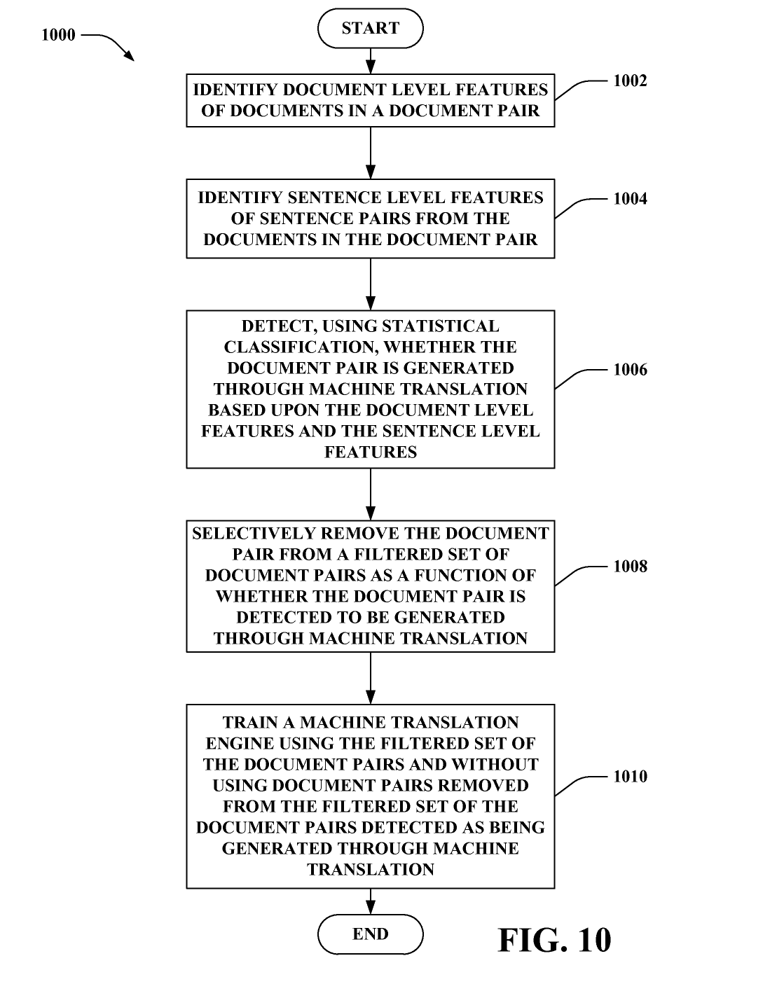

FIGS. 9-10 illustrate exemplary methodologies relating to machine translation detection. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 9 illustrates a methodology 900 for detecting machine translated content. At 902, document level features of documents in a document pair can be identified. The documents in the document pair are mutual lingual translations of each other. Further, the document level features correlate with translation quality between the documents in the document pair. At 904, statistical classification can be used to detect whether the document pair is generated through machine translation based at least in part upon the document level features. For instance, a first document can be a machine translation of at least a second document in the document pair or a disparate document when generated through machine translation.

Turning to FIG. 10, illustrated is a methodology 1000 for detecting and removing machine translated content from a set of document pairs used to train a machine translation engine. At 1002, document level features of documents in a document pair can be identified. The documents in the document pair are mutual lingual translations of each other. Moreover, the document level features correlate with translation quality between the documents in the document pair. At 1004, sentence level features of the sentence pairs from the documents in the document pair can be identified. The sentence pairs can respectively include aligned sentences from the documents in the document pair. Further, the sentence level features correlate with translation quality between sentences within the documents in the document pair.

At 1006, statistical classification can be used to detect whether the document pair is generated through machine translation based upon the document level features and the sentence level features. For instance, a first document can be a machine translation of a second document in the document pair or a disparate document when generated through machine translation. At 1008, the document pair can be selectively removed from a filtered set of document pairs as a function of whether the document pair is detected to be generated through machine translation. At 1010, a machine translation engine can be trained using the filtered set of the document pairs and without using document pairs removed from the filtered set of the document pairs detected as being generated through machine translation.

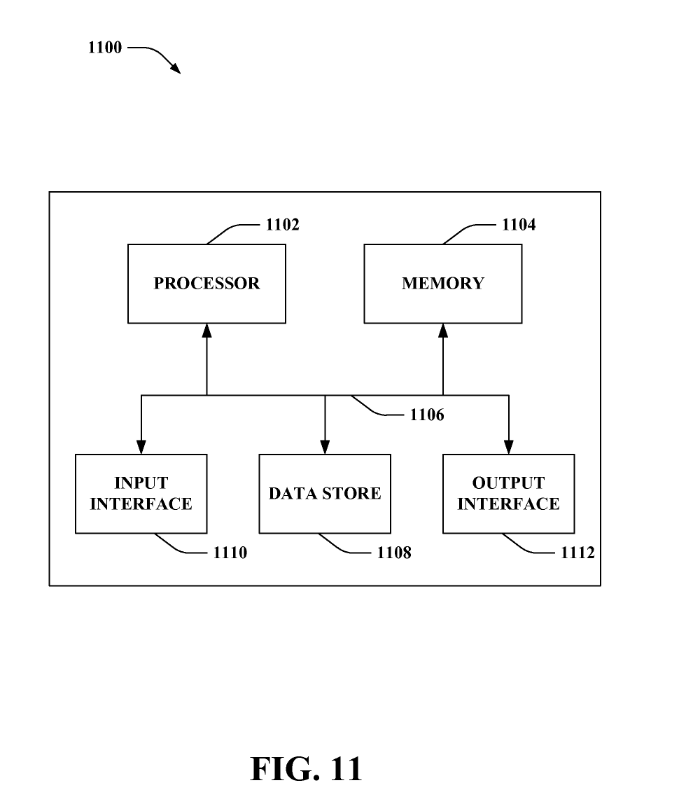

Referring now to FIG. 11, a high-level illustration of an exemplary computing device 1100 that can be used in accordance with the systems and methodologies disclosed herein is illustrated. For instance, the computing device 1100 may be used in a system that detects machine translated content. By way of another example, the computing device 1100 can be used in a system that removes detected machine translated content from web-scraped parallel corpora, and uses the web-scraped parallel corpora with the machine translated content removed to train a machine translation engine. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store document pair(s), extracted feature(s), and so forth.

The computing device 1100 additionally includes a data store 1108 that is accessible by the processor 1102 by way of the system bus 1106. The data store 1108 may include executable instructions, document pair(s), extracted feature(s), etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of detecting machine translated content, comprising:
identifying document level features of documents in a document pair, wherein the documents in the document pair are mutual lingual translations of each other and the document level features correlate with translation quality between the documents in the document pair; and
causing a processor to detect, using statistical classification, whether the document pair is generated through machine translation based at least in part upon the document level features, wherein a first document is a machine translation of at least a second document in the document pair or a disparate document when generated through machine translation.

2. The method of claim 1, further comprising collecting a set of document pairs including the document pair through web-scraping.

3. The method of claim 2, further comprising detecting, using the statistical classification, a subset of the document pairs as being generated through machine translation based at least in part upon the document level features.

4. The method of claim 3, further comprising:
removing the subset of the document pairs detected as being generated through machine translation from the set of the document pairs to produce a filtered remainder of the document pairs; and
training a machine translation engine using the filtered remainder of the document pairs and without using the subset of the document pairs detected as being generated through machine translation.

5. The method of claim 4, further comprising translating a different document with the machine translation engine as trained.

6. The method of claim 1, further comprising:
identifying sentence level features of sentence pairs from the documents in the document pair, wherein the sentence pairs respectively include aligned sentences from the documents in the document pair and the sentence level features correlate with translation quality between sentences within the documents in the document pair; and
detecting, using the statistical classification, whether the document pair is generated through machine translation based upon the document level features and the sentence level features.

7. The method of claim 6, wherein detecting, using the statistical classification, whether the document pair is generated through machine translation based upon the document level features and the sentence level features further comprises:
determining respective sentence level scores for the sentence pairs by inputting the sentence level features into a sentence level classifier, wherein the respective sentence level scores are probabilistic measures related to whether the corresponding sentence pairs are generated through machine translation or human translation;
generating a derived document level feature based on the sentence level scores; and
determining a document level score for the document pair by inputting the document level features and the derived document level feature generated based on the sentence level scores into a document level classifier, wherein the document level score is a probabilistic measure related to whether the document pair is generated through machine translation or human translation.

8. The method of claim 6, wherein the sentence level features comprise at least function word features that correspond to patterns of function words in the sentence pairs.

9. The method of claim 6, wherein the sentence level features comprise at least suffix features that correspond to patterns in morphology and parts of speech for words in context.

10. The method of claim 1, wherein the statistical classification is performed by at least one maximum entropy classifier.

11. The method of claim 1, wherein the document level features of the documents comprise at least a respective static rank of each of the documents in the document pair.

12. The method of claim 1, further comprising indexing the documents in the document pair as a function of whether the document pair is generated through machine translation.

13. A system that detects and filters machine translated content, comprising:
a classification component that detects a subset of document pairs from a set of document pairs as being generated through machine translation, wherein documents in a given document pair from the set of the document pairs are mutual lingual translations of each other and a first document in a particular document pair is a machine translation of at least a second document in the particular document pair or a disparate document when the particular document pair is generated through machine translation;
a filter component that removes the subset of the document pairs detected as being generated through machine translation from the set of document pairs to produce a filtered remainder of the document pairs; and
a training component that trains a machine translation engine using the filtered remainder of the document pairs and without using the subset of the document pairs detected as being generated through machine translation.

14. The system of claim 13, wherein the classification component detects the subset of the document pairs as being generated through machine translation based on sentence level features.

15. The system of claim 13, wherein the classification component detects the subset of the document pairs as being generated through machine translation based on document level features.

16. The system of claim 13, wherein the classification component detects the subset of the document pairs as being generated through machine translation based on document level features and sentence level features.

17. The system of claim 13, further comprising a collection component that employs web-scraping to collect the set of document pairs from websites.

18. The system of claim 13, wherein the classification component assigns respective scores to the document pairs in the set of document pairs based on corresponding confidences that lingual translations are adequate and fluent.

19. The system of claim 13, further comprising an extraction component that extracts a feature from the document pairs in the set of document pairs, wherein the feature is used by the classification component to detect the subset of the document pairs as being generated through machine translation.

20. A computer-readable storage medium including computer-executable instructions that, when executed by a processor, cause the processor to perform acts including:
identifying document level features of documents in a document pair, wherein the documents in the document pair are mutual lingual translations of each other and the document level features correlate with translation quality between the documents in the document pair;
identifying sentence level features of sentence pairs from the documents in the document pair, wherein the sentence pairs respectively include aligned sentences from the documents in the document pair and the sentence level features correlate with translation quality between sentences within the documents in the document pair;
detecting, using statistical classification, whether the document pair is generated through machine translation based upon the document level features and the sentence level features, wherein a first document is a machine translation of a second document in the document pair or a disparate document when generated through machine translation;
selectively removing the document pair from a filtered set of document pairs as a function of whether the document pair is detected to be generated through machine translation; and
training a machine translation engine using the filtered set of the document pairs and without using document pairs removed from the filtered set of the document pairs detected as being generated through machine translation.
